(19) United States
(12) Patent Application Publication
(10) Pub. No.: US 2002/0065754 A1
(43) Pub. Date: May 30, 2002

(54) System and method for increasing office space income to reduce particular tenant(s) office space costs and/or increase landlord(s) income

(76) Inventor: Craig H. Lussi, Kensington, MD (US)

Correspondence Address: MORGAN LEWIS & BOCKIUS LLP, 1111 PENNSYLVANIA AVENUE NW, WASHINGTON, DC, 20004, US

(21) Appl. No.: 09/947,396

(22) Filed: Sep. 7, 2001

Related U.S. Application Data
(60) Provisional application No. 60/232,066, filed on Sep. 12, 2000.

(51) Int. Cl. G06F 17/00; G06F 17/60

(52) U.S. Cl. 705/35

(57) ABSTRACT

The disclosed method and system provide a way to increase the income generated from office space to reduce office space rental costs and/or to increase the landlord's income, the system and method involving a business arrangement among one or more of the landlord, good credit tenant(s), and a shared office provider or other having shared office experience/expertise.

### FIELD OF THE INVENTION

The present invention relates to a system and method for increasing office space income to reduce particular tenant(s) office space costs and/or increase landlord(s) income.

### BACKGROUND OF THE INVENTION

Traditionally, a landlord will lease office space to a tenant for a specified amount of rent often quoted on an annual or monthly cost per square foot (for example, $30 per square foot per year). Tenants (excluding shared office/executive suites/instant office providers—collectively “Shared Office Providers”) try to anticipate their office space growth or office space reduction needs with expansion or contraction options in their leases. Unfortunately, tenants often have to sublease excess space at a minimal profit, and even a loss, depending on market conditions. In addition, the tenants must expend time and resources to sublease the excess space, the tenants, desiring to focus on their particular businesses, typically trying to avoid participation in the real estate/subleasing business. For example, a law firm needing office space for its lawyers and support personnel does not want to expend resources trying to sublease any excess space to computer software companies.

As shown in FIG. 1, Shared Office Providers, such as Regus Business Centers and HQ Global Workplaces, traditionally lease office space as a tenant and then provide filly equipped and staffed instant offices to short term tenants. These short term tenants (“Shared Office Tenants”) often do not desire to make the normal capital investment, such as copiers, fax machines, phone systems, Internet service, secretarial support, mail service, FedEx service, furniture, kitchens, or health club access that is required for conventional office space. Therefore, Shared Office Tenants are often willing to pay as much as or more than three (3) times the per square foot rent to the Shared Office Provider than other non-shared office tenants in a particular building.

Shared Office Providers typically lease or buy in bulk items, such as phone systems, furniture, copy machines, construction of office space, etc. for the shared office tenant's use. The Shared Office Providers dramatically mark up the cost of these items to their shared office users. Thus, after expenses, the average shared office operation generates 100% to 175% of the Shared Office Provider's per square foot rent cost in profit. For example, a Shared Office Provider charging $90 per square foot in gross rent usually is paying $30 per square foot in rent and has expenses of $13 to $20 per square foot. Thus, the Shared Office Provider is generating $40 to $47 per square foot in profit (or 143% to 156% of the Shared Office Provider's rent in profit).

Although the business of Shared Office Providers has always been highly profitable, these businesses have not been considered good credit tenants because of the widely differing nature of the products and services provided, short term commitments of the shared office tenants, and potentially shaky credit. Recently, after huge expansion and acquisition campaigns, some of the worldwide Shared Office Providers improved their credit rating by successfully marketing to upscale shared office clients, such as Microsoft, BMW, Merrill Lynch, etc. However, the average stay of a shared office client is still only ten (10) months. Thus, landlords, lenders, appraisers and investors/purchasers of office buildings still do not put shared office business on the same credit level as corporations, financial institutions, associations and law firms. This lower credit level can be disastrous because a building's value is directly dependent on the level of credit of the building's tenants.

In the past, landlords often have attempted to reap some portion of the high shared office profits by forming partnerships with Shared Office Providers as illustrated in FIG. 2. However, because of the short term leases of the shared office clients and the fact that the landlord is no longer just a landlord but a partner with one of the landlord's tenants, lenders, appraisers, investors/purchasers and real estate investment trusts underwriters oftentimes will penalize the buildings' value even if the cash flow is equal to a building with non-shared office, non-landlord partnered tenants.

### SUMMARY OF THE INVENTION

Accordingly, the present invention provides a method and a system that substantially obviates one or more of the problems due to limitations and disadvantages of the related art.

An object of the present invention is to provide a system and method that increases office space income to reduce particular tenants' office space costs and/or increase landlords' income and building value in commercial office buildings by having good credit tenants, such as corporations, financial institutions, associations, and law firms, partner with a Shared Office Provider or other having shared office expertise/experience; establishing shared office operations in office markets where good credit tenants have established shared office operations with similar shared office management; or having landlords offer some office space in office markets where good credit tenants have established shared office operations with similar shared office management. This is accomplished by forming partnerships with the credit tenant(s) and a Shared Office Provider(s) to be managed as shared office space, or forming partnerships between a credit tenant, and/or Shared Office Provider, and/or a landlord who has been skilled in the art and educated how to manage a shared office operation. Tenants can dramatically reduce their rental costs and landlords can dramatically increase their net operating income without sacrificing office buildings' values because good credit tenants have their credit spread over all of the leased space, or landlords are able to partner with good credit tenants, or landlords are benefiting from good credit tenants performing shared office businesses in a particular office building and market.

Additional features and advantages for tenants and landlords include more flexible expansion and contraction capabilities, additional revenue and reasons to maintain the “latest and greatest” office space technology and infrastructure, access to an almost unlimited pool of expertise, consultants, labor, etc. from many diverse industries (the shared office users). There also will be additional revenue from the sale by landlords and/or tenants of exclusive shared office rights in buildings where landlords, because of ownership, or tenants, because of lease rights, control the shared office activities in these buildings.

Additional features and advantages of the invention will be set forth in the description that follows, and in part will be apparent from the description, or may be learned by practice of the invention. The objectives and other advantages of the invention will be realized and attained by the structure particularly pointed out in the written description as well as the appended drawings.

To achieve these and other advantages and in accordance with the purpose of the invention, as embodied and broadly described, the present invention provides a method and system for offsetting the costs incurred when renting or leasing office space in any location. The system and method allow the costs to be further offset by providing basic services to a third party who occupies the shared space. These basic services can include office furniture, telephone lines, Internet connections, network connections, and human resources, such as office assistants and staff members.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 illustrates a prior art shared office business arrangement.

FIG. 2 illustrates a prior art shared office business arrangement.

FIG. 3 illustrates an embodiment of a shared office business arrangement of the present invention.

FIG. 4 illustrates an embodiment of a shared office business arrangement of the present invention.

FIG. 5 illustrates the first stabilized year of overall occupancy cost for a tenant that has leased a specified amount of space and uses a portion of that space for a shared office in order to offset its over all cost for various embodiments of the present invention.

FIG. 6 illustrates the first stabilized year of overall occupancy cost for a tenant that has leased a specified amount of space and uses a portion of that space for a shared office in order to offset its over all cost for other embodiments of the present invention.

FIG. 7 illustrates the first stabilized year of net income for a landlord that uses a specific amount of space in its building(s) for a shared office business in order to increase its overall revenue without increasing the size of the building(s) for various embodiments of the present invention.

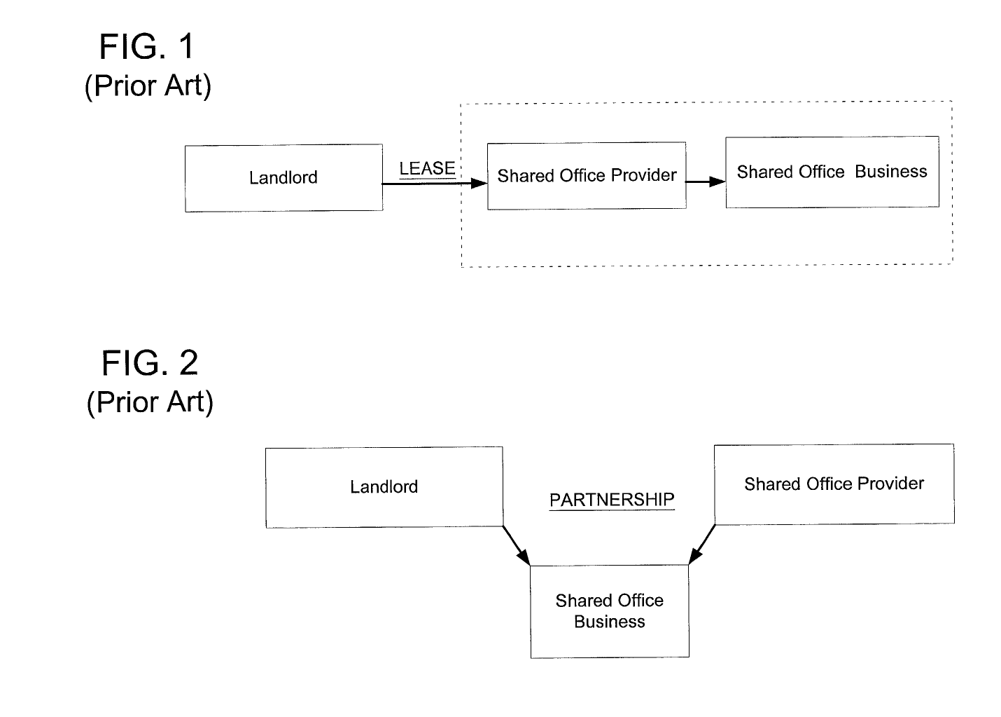

### DETAILED DESCRIPTION OF THE PREFERRED EMBODIMENTS

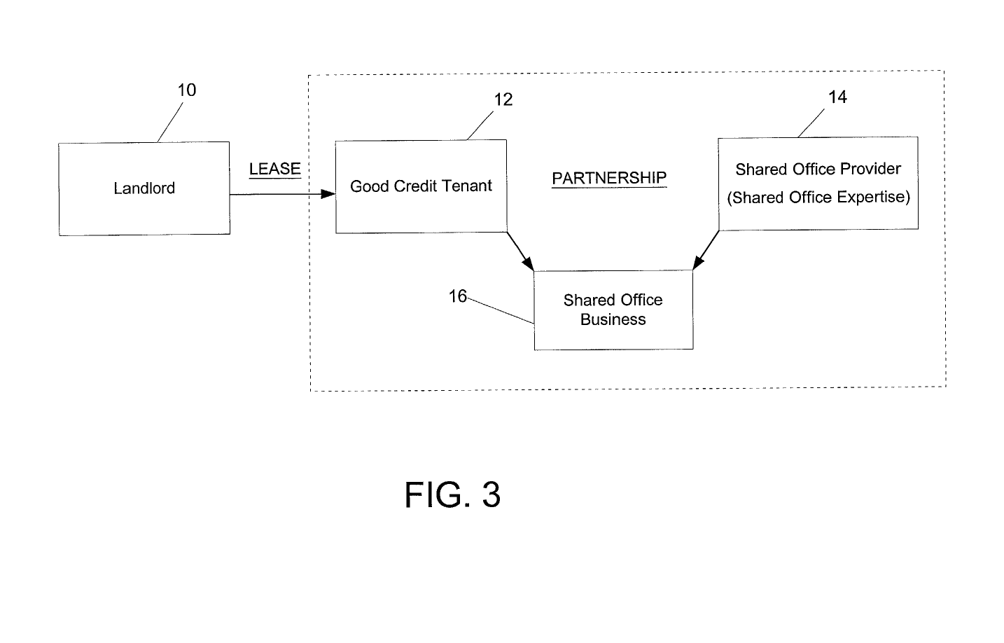

FIG. 3 illustrates an embodiment of the present invention in which a landlord 10 leases office space to a Good Credit Tenant 12, the Good Credit Tenant 12 forming a partnership with a Shared Office Provider 14 to provide a shared office business 16 using any excess of the leased office space. The term “partner” and forms thereof used in context with the present invention are intended for association with a partnership, joint venture or similar business arrangement between the pertinent parties. Further, a Good Credit Tenant is any entity that has demonstrated a long term source of income and is generally a sophisticated business entity. A Good Credit Tenant need not be securitized or bonded, but is one that is recognized by lenders and investors as financially sound and having an appropriate credit rating. Finally, the subleases provided to the shared office tenants as part of the shared office business may be for varying time periods to include hours, days, months, and years.

In the embodiment of FIG. 3, the Good Credit Tenant 12 offsets the office space rental costs using the profit generated by the shared office business 16. This offset may occur directly by the Good Credit Tenant 12 retaining its shared office rights and applying its portion of the profits to its rental costs or indirectly by the assignment of its shared office rights to an affiliate or other related business entity. The Good Credit Tenant 12 may further benefit from the arrangement illustrated in FIG. 3 by renting the total existing office space in a building or by requiring through the lease agreement that no other tenant nor the landlord may provide shared office services in the same building. The landlord 10 also benefits from this shared office arrangement in that the Good Credit Tenant 12 has its credit spread over the entire leased office space increasing the value of the building. While not necessarily true of the landlord, the tenant in this embodiment benefits from the shared office business arrangement regardless of any status as a Good Credit Tenant. Other embodiments, such as the leasing of office space to multiple Good Credit Tenants and the forming of a partnership among the multiple Good Credit Tenants and a shared office provider or those having shared office expertise and/or experience, will be known to the ordinary artisan and are within the scope of the present invention.

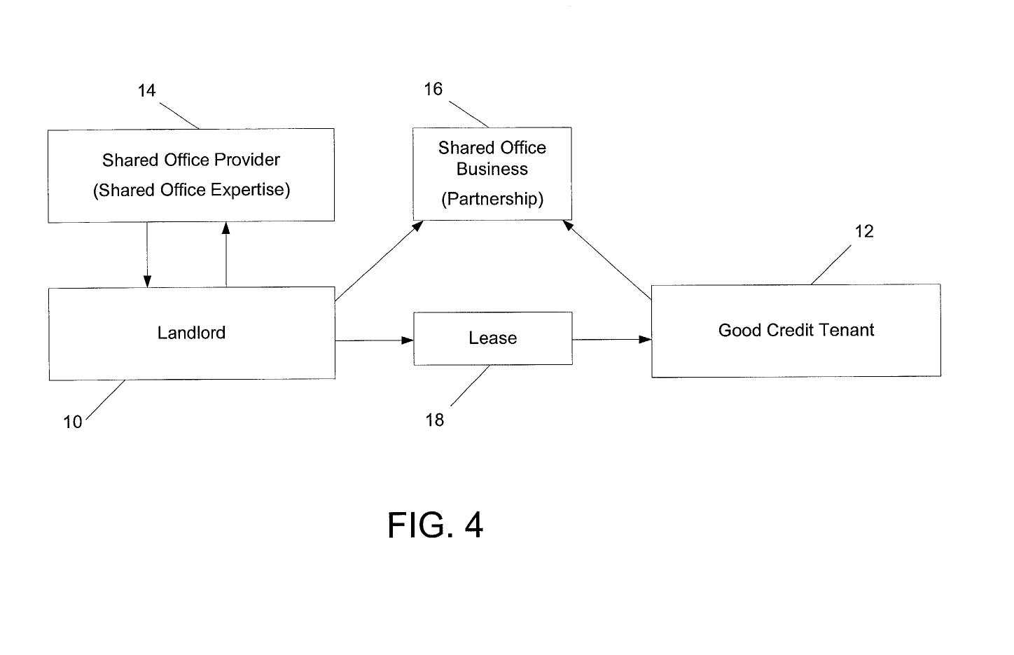

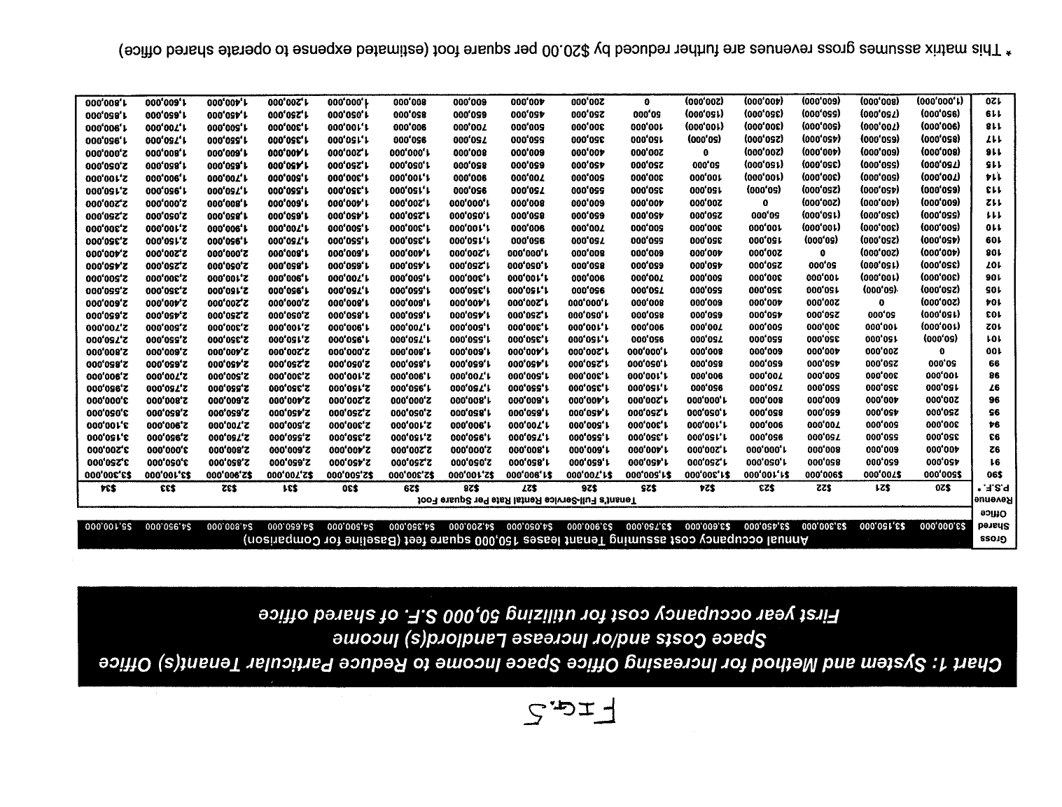

FIG. 4 illustrates another embodiment of the present invention in which the landlord 10, having shared office experience or employing/partnering with a shared office provider 14, leases office space to a Good Credit Tenant 12, the landlord 10 and Good Credit Tenant 12 forming a partnership to provide a shared office business 16 using any excess of the leased office space. In this embodiment, the landlord increases its net operating income due to a portion of the profit from the shared office business 16; the Good Credit Tenant 12 offsets its office space rental costs using a portion of the profit from the shared office business 16; and the value of the building increases due to the credit of the Good Credit Tenant 12 and the fact that this good credit is spread over more office space. The landlord 10 may further benefit by requiring through the lease agreement that the Good Credit Tenant 12 only sublease office space in connection with the shared office business. Other embodiments, such as the leasing of Office Space to multiple Good Credit Tenants and the forming of a partnership among the multiple Good Credit Tenants and the landlord, will be known to the ordinary artisan and are within the scope of the present invention.

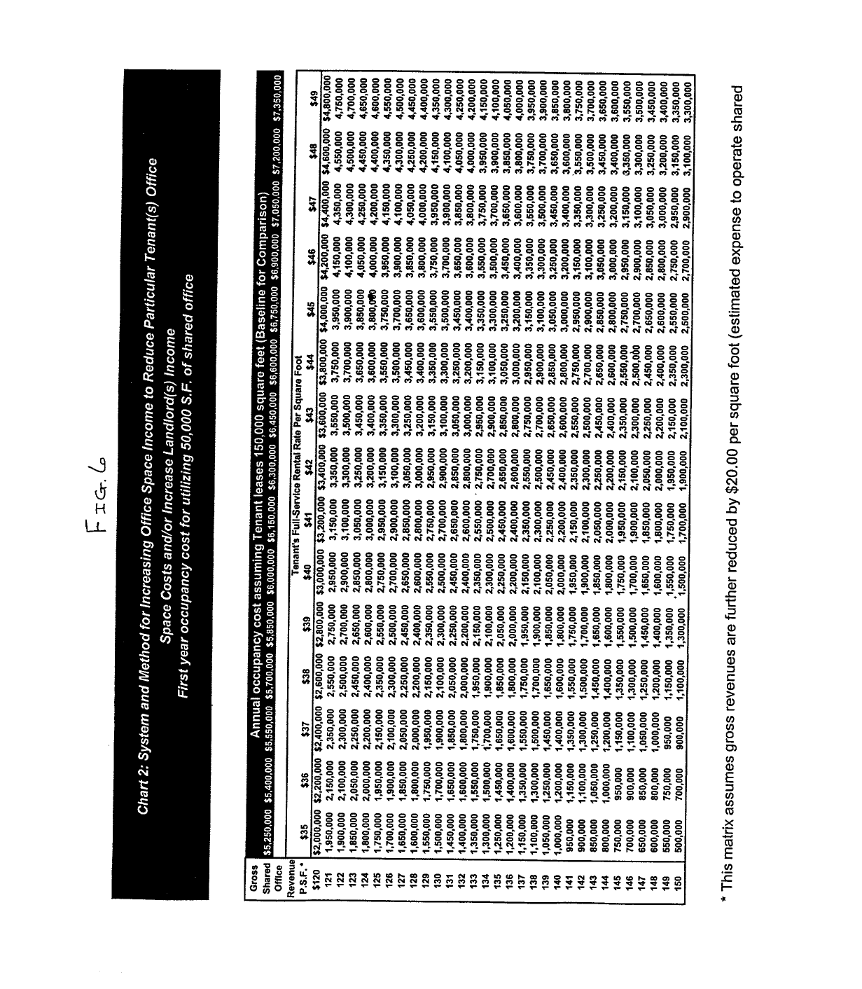

FIG. 5 illustrates a detailed chart for the first stabilized year occupancy cost for a tenant that leases 200,000 square feet and offsets occupancy costs by using 50,000 square feet for shared-office space in a market whose full service rental rates range from $20 per square foot to $34 per square foot and where gross shared office revenues range from $90 to $120 per square foot. In one embodiment of the invention, shown as the first entry in the chart of FIG. 5, the tenant pays the building landlord $20 per square foot. Thus, the total price for the leased 200,000 square feet is $4,000,000. The tenant only needs to occupy 150,000 square feet of the building (which at $20 per square foot is shown on the chart as $3,000,000) for its use, so the tenant sets up, or has a third party Shared Office Provider run a shared office business in the additional 50,000 square feet. The gross shared office revenues are $90 per square foot. As will be known to those skilled in the art, an estimated expense to operate shared office space is $20 per square foot. Thus, the 50,000 square feet generates the following income from the shared office operations: $90−$20=$70 per square foot. The net revenue to the tenant of the shared office operation is: (50,000 square feet)×($70 per square foot)=$3,500,000. Subtracting the $3,500,000 from the original $4,000,000 paid to lease the 200,000 square feet, the actual occupancy cost to the tenant for the leased space is $500,000 instead of $3,000,000.

Another embodiment of the invention is illustrated, for example, in the sixth column, line 1, of the chart in FIG. 5. In this embodiment, the tenant leases the 200,000 square feet for $25 per square foot even though the tenant only needs 150 square feet at a cost of $3,750,000. The tenant's payment for the 200,000 square, therefore, is $5,000,000. The gross shared office revenues are $90 per square foot for the 50,000 square feet. Again, the expenses to operate the shared office is $20 per square foot, reducing the income to the tenant to $70 per square foot, or $3,500,000 total. Thus, the tenant's actual occupancy cost is $1,500,000 (as opposed to the $3,750,000).

However, consider if the gross shared office revenue is $100 per square foot. The tenant's actual occupancy cost is reduced to $1,000,000.

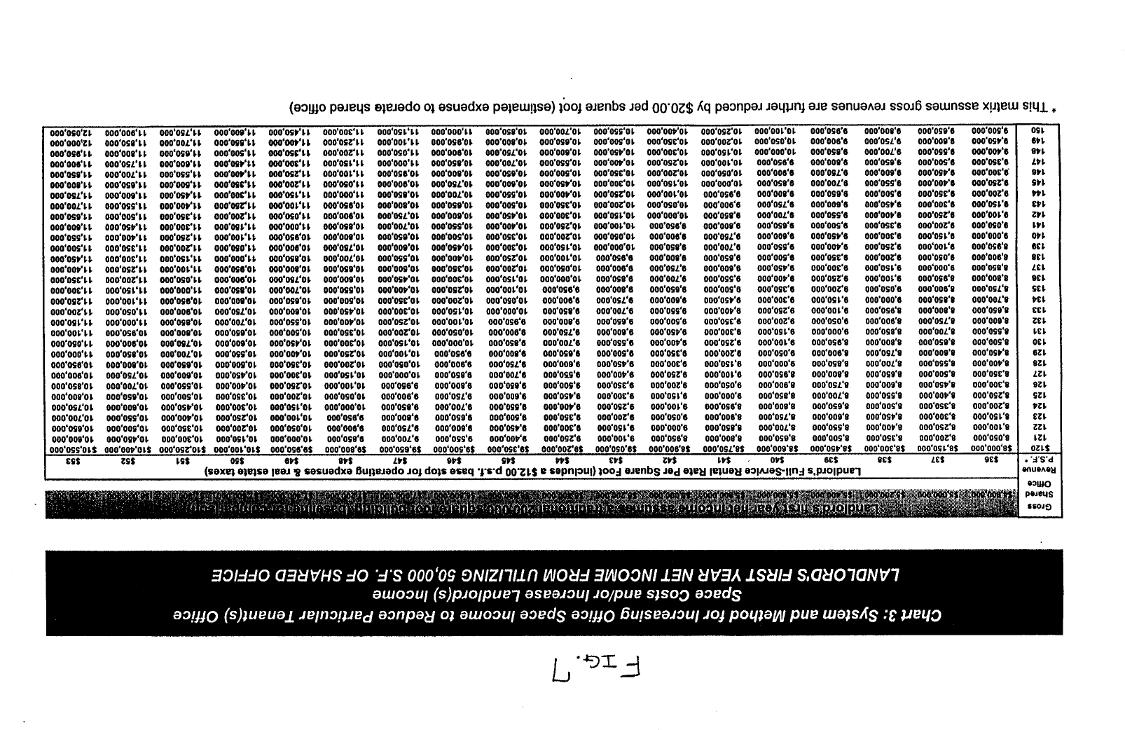

FIG. 6 illustrates another embodiment of the present invention. This figure is similar to FIG. 5, but illustrates a tenant's saving when the tenant pays, for example, an increased rental rate of $35 per square foot, and runs a shared office business at a gross shared office revenue at $120 per square foot. As is shown in the first column, line 1, of the chart of FIG. 6, the tenant's total cost to rent 200,000 square feet, with a shared office of 50,000 would be $2,000,000, as opposed to $5,250,000 without the shared office.

Additionally, income from the shared office can be further increased and the tenants' rent further decreased by providing additional services to the users of the shared office. Such services can include phone lines, Internet connections, network connections, teleconferencing, computer equipment, office furniture, secretarial support, desktop publishing and any other items associated with running a shared office business. Furthermore, office assistants, and staff members can be provided. All of these additional services to the users of the shared office space further increase the shared office income.

FIG. 7 illustrates a detailed chart for the first stabilized year of occupancy for a landlord owning a 200,000 square foot building and who increases net income by using 50,000 square feet as a shared office operation and the remaining 150,000 square feet as conventional office space. Those skilled in the art recognize that the landlord's net income must be adjusted to consider operating expenses and real estate taxes (in this example, the net income was adjusted by $12 per square foot). Thus, were the landlord to receive full service rent for the entire 200,000 square feet at a rental rate of $36 per square foot, the net income would be (200,000 square feet)×($36 per square foot−$12 per square foot expenses)=$4,800,000. However, if the landlord uses 50,000 square feet as a shared office operation, the net income the landlord would receive on 150,000 square feet at the full service rent, after paying operating expenses and real estate taxes of approximately $12 per square foot, would be $3,600,000 annually (150,000 square feet)×($36 per square foot−$12 per square foot expenses). The landlord would also receive gross revenue of $120 per square foot on the 50,000 square feet of shared office space. As will be known to those skilled in the art, an estimate expense to operate shared office space is $20 per square foot Thus, the 50,000 square feet generates the following income from shared office operations: $120−20=$100 per square foot. The net revenue to the landlord of the shared office operation is (50,000 square feet)×($100 per square foot)=$5,000,000. Subtracting the $12 per square foot of operating expenses and real estate taxes the landlord has to pay on the 50,000 square feet would be ($12 per square foot)×(50,000 square feet)=$600,000, which is subtracted from the net revenue of $5,000,000− or $4,400,000 in additional net income. Thus, the landlord would receive $8,000,000 total income rather than $4,800,000 under conventional methods and practice. This $3.2 million in additional landlord net income represents an increase in annual building income by 67%; and a building value increase of a similar percentage.

From the tenant's perspective, an office lease can be converted from a liability and a necessary evil of doing business to a system and method to dramatically reduce, and even eliminate rent expense while still performing a tenant's or landlord's core business operation(s). In the future, shared office buildings will be viewed more like hotels with Shared Office Provider(s) reducing costs and/or giving discounts to good credit tenants in exchange for commitments from good credit tenants to use shared office space, thereby enhancing the Shared Office Provider(s) credit with landlord(s), lender(s), and investor(s) in the same way good credit tenants enhance the value of an office building today. Good credit tenants willing to participate in some form of shared office activities and/or partnerships is the pre-cursor to office building(s) that function more like hotels. Currently the value of office buildings with identical net income and location is determined by the credit of the office building's tenants and the tenant's term of commitment. Unlike hotels, office building values rely on longer term commitments by the tenants, typically 3 to 10 years or more. Hotels and Shared Office Providers are similar in that they both give the tenant limited space configuration options (although hotel rooms are not remodeled for each new guest) so that short term rentals are feasible. Over time, tenants will appreciate the benefit of just using the office space they need at a particular time rather than carrying office space for all employees regardless of daily usage (i.e., not everyone in a company occupies space in one location at one time—employees travel, have meetings, visit clients, etc), and generate a demand for shared office buildings. In these new shared office buildings, tenants will no longer require remodeling of the office space, and accordingly, lenders and investors will give these shared office buildings (or larger portions of buildings) high values once the office space is not continually torn out and rebuilt. The disclosed invention is the transition tool to these future shared office buildings.

While the invention has been described in detail and with reference to specific embodiments thereof, it will be apparent to one skilled in the art that various changes and modification can be made therein without departing from the spirit or scope thereof. For example, it will be known to one of ordinary skill in the art that the rates, costs, expenses, and taxes mentioned in association with the present invention are a function of time and the relevant market; changes in these values are anticipated, will be known to one of ordinary skill in the art, and are within the scope of the present invention. Thus, it is intended that the present invention covers the modifications and variations of this invention provided they come within the scope of the appended claims and their equivalents.

What is claimed is:

1. A method for offsetting a tenant's office space rental costs comprising the steps of:
leasing a determined amount of office space from a landlord for a determined rate, thereby generating the office space rental costs;
appropriating a portion of the leased office space for shared office users, wherein the determined amount of office space exceeds the portion of the leased office space;
equipping at least the portion of the leased office space to be functional as shared office space;
having a partner run a shared office business in the portion of the leased office space;
charging shared office rates for use of the portion of the leased office space; and
using an excess of income generated by the shared office business in the portion of the leased space to offset the office space rental costs.

2. The method of claim 1 wherein the determined amount of office space comprises all the existing office space in a particular building.

3. The method of claim 1 wherein the landlord is prohibited from running or permitting another tenant to run a separate shared office business in the same building as the determined amount of office space.

4. The method of claim 1 wherein equipping the portion of the leased office space to be functional as shared office space varies with the needs of shared office users.

5. The method of claim 1 wherein a time period for using the portion of the leased office space varies with the needs of shared office users and may be one of hours, days, months, or years.

6. The method of claim 1 wherein the partner is the landlord.

7. The method of claim 1 further comprising the step of running a non-shared office business in the determined amount of office space not apportioned for the shared office users.

8. The method of claim 1 wherein the tenant is a good credit tenant.

9. The method of claim 8 wherein the determined amount of office space comprises the existing office space in a particular building.

10. The method of claim 1 wherein the landlord is prohibited from running or permitting another tenant to run a separate shared office business in the same building as the determined amount of office space.

11. The method of claim 8 wherein the partner is the landlord.

12. The method of claim 1 wherein the determined rate and the shared office rates are a function of time and the office market.

13. The method of claim 8 wherein the determined rate and the shared office rates are a function of time and the office market.

14. The method of claim 8 further comprising the step of running a non-shared office business in the determined amount of office space not apportioned for the shared office users.

15. The method of claim 14 wherein the determined rate and the shared office rates are a function of time and the office market.

16. The method of claim 15 wherein the excess of income is applied directly to the office space rental costs to reduce the office space rental costs.

17. A method for offsetting a tenant's office space rental costs comprising the steps of:
leasing a determined amount of office space from a landlord for a determined rate, thereby generating the office space rental costs;
appropriating a portion of the leased office space for shared office users, wherein the determined amount of office space exceeds the portion of the leased office space;
equipping at least the portion of the leased office space to be functional as shared office space;
running a shared office business in the portion of the leased office space;
charging shared office rates for use of the portion of the leased office space; and
using an excess of income generated by the shared office business in the portion of the leased space to offset the office space rental costs.

18. The method of claim 17 wherein the determined amount of office space comprises all the existing office space in a particular building.

19. The method of claim 17 wherein the landlord is prohibited from running or permitting another tenant to run a separate shared office business in the same building as the determined amount of office space.

20. The method of claim 17 wherein equipping the portion of the leased office space to be functional as shared office space varies with the needs of the shared office users.

21. The method of claim 17 wherein a time period for using the portion of the leased office space varies with the needs of shared office users and may be one of hours, days, months, or years.

22. The method of claim 17 further comprising the step of running a non-shared office business in the determined amount of office space not apportioned for the shared office users.

23. The method of claim 17 wherein the tenant is a good credit tenant.

24. The method of claim 23 wherein the determined amount of office space comprises all the existing office space in a particular building.

25. The method of claim 17 wherein the landlord is prohibited from running or permitting another tenant to run a separate shared office business in the same building as the determined amount of office space.

26. The method of claim 17 wherein the determined rate and the shared office rates are a function of time and the office market.

27. The method of claim 23 wherein the determined rate and the shared office rates are a function of time and the office market.

28. The method of claim 23 further comprising the step of running a non-shared office business in the determined amount of office space not apportioned for the shared office users.

29. The method of claim 28 wherein the determined rate and the shared office rates are a function of time and the office market.

30. The method of claim 28 wherein the excess of income is applied directly to the office space rental costs to reduce the office space rental costs.

31. A method for increasing the net operating income of a landlord comprising the steps of:
leasing a first determined amount of office space in a building to a tenant at a full service rental rate, wherein the tenant is a good credit tenant;
having a partner run a shared office business in a portion of the first determined amount of office space, wherein the first determined amount of office space exceeds the portion of the first determined amount of office space;
charging shared office rates for use of the portion of the first determined amount of office space; and
generating an excess amount of income represented by a difference between a profit generated by the shared office business and the full service rate.

32. The method of claim 31 wherein the full service rental rate and the shared office rates are a function of time and the office market.

33. The method of claim 32 wherein the tenant can use the portion of the first determined amount of office space only in connection with the shared office business.

34. The method of claim 31 wherein the tenant runs a non-shared office business in the determined amount of office space not utilized by the shared office business.

35. The method of claim 34 wherein the full service rental rate and the shared office rates are a function of time and the office market.

36. The method of claim 31 wherein the tenant is a second partner in the shared office business.

37. The method of claim 36 wherein the full service rental rate and the shared office rates are a function of time and the office market.

38. The method of claim 37 wherein the tenant can use the portion of the first determined amount of office space only in connection with the shared office business.

39. The method of claim 37 wherein a time period for using the portion of the leased office space varies with the needs of shared office users and may be one of hours, days, months, or years.

40. The method of claim 36 wherein the tenant runs a non-shared office business in the determined amount of office space not utilized by the shared office business.

41. The method of claim 40 wherein the full service rental rate and the shared office rates are a function of time and the office market.

42. The method of claim 41 wherein the tenant can use the portion of the first determined amount of office space only in connection with the shared office business.

43. A method for increasing the net operating income of a landlord comprising the steps of:
leasing a first determined amount of office space in a building to a tenant at a full service rental rate, wherein the tenant is a good credit tenant;
running a shared office business in a portion of the first determined amount of office space, wherein the first determined amount of office space exceeds the portion of the first determined amount of office space;
charging shared office rates for use of the portion of the first determined amount of office space; and
generating an excess amount of income represented by a difference between a profit generated by the shared office business and the full service rate.

44. The method of claim 43 wherein the full service rental rate and the shared office rates are a function of time and the office market.

45. The method of claim 43 wherein the tenant runs a non-shared office business in the determined amount of office space not utilized by the shared office business.

46. The method of claim 43 wherein the tenant can use the portion of the first determined amount of office space only in connection with the shared office business.

47. The method of claim 45 wherein the full service rental rate and the shared office rates are a function of time and the office market.

48. The method of claim 43 wherein the tenant is a partner in the shared office business.

49. The method of claim 48 wherein the tenant runs a non-shared office business in the determined amount of office space not utilized by the shared office business.

50. The method of claim 49 wherein the full service rental rate and the shared office rates are a function of time and the office market.

51. The method of claim 50 wherein the tenant can use the portion of the first determined amount of office space only in connection with the shared office business.

52. The method of claim 50 wherein a time period for using the portion of the leased office space varies with the needs of shared office users and may be one of hours, days, months, or years.
